(19) United States
(12) Patent Application Publication
(10) Pub. No.: US 2011/0136467 A1
(43) Pub. Date: Jun. 9, 2011

(54) Communication Link Connection Indication Signal Method and Apparatus Employing Promotional Content

(76) Inventor: Brockett Muir, III, Washington, DC (US)

(21) Appl. No.: 12/961,997

(22) Filed: Dec. 7, 2010

Related U.S. Application Data
(60) Provisional application No. 61/267,692, filed on Dec. 8, 2009.

(51) Int. Cl. H04M 11/00

(52) U.S. Cl. 455/405

(57) ABSTRACT

A wireless communication device (20) is provided (12) with at least one promotional message. Upon determining (13) that a communication link for that wireless communication device with a third party is established, at least one promotional message is provided (14) at the communication device to indicate establishment of that communication link to a user of the communication device. In a preferred approach the promotional message is unique in that the signal is not used for other annunciation or notice purposes. For example, the communication device will not use this signal to also indicate the existence of an incoming call.

### RELATED APPLICATION(S)

This application claims the benefit of U.S. Provisional Application number 61/267,692, filed Dec. 8, 2009, which is incorporated by reference in its entirety herein.

### TECHNICAL FIELD

This invention relates generally to communication link usage and more particularly to communication link status indication.

### BACKGROUND

Communication devices comprise a generally well-understood area of endeavor including, but not limited to, two-way communications based upon, for example, wireless cellular telephony and the like. In many communication systems the system infrastructure will assign or otherwise facilitate the allocation of wireless resources (such as, but not limited to, radio frequency carriers, time slots, spreading codes, and so forth) to support a given communication session. The constituent elements and the totality of such allocated wireless resources can be viewed as a communication link.

There are times when confusion can arise with respect to whether a given communication link has, in fact, become connected. For example, a given user may perceive, incorrectly, that a given communication link has been connected but fail to take an appropriate action to actually effect the connection of that communication link. This, in turn, can lead to user frustration, inefficient use of resources, and wasted time.

### BRIEF DESCRIPTION OF THE DRAWINGS

The above needs are at least partially met through provision of the communication link termination indication signal method and apparatus employing promotional content described in the following detailed description, particularly when studied in conjunction with the drawings, wherein:

FIG. 1 comprises a flow diagram as configured in accordance with various embodiments of the invention; and

FIG. 2 comprises a block diagram as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a wireless communication device is provided with at least one promotional message. Upon determining that a communication link for that wireless communication device with a third party is established, at least one promotional message is provided at the communication device to indicate establishment of that communication link to a user of the communication device. In a preferred approach the promotional message is unique in that the signal is not used for other annunciation or notice purposes. For example, the communication device will not use this signal to also indicate the existence of an incoming call.

In a preferred approach the promotional message comprises audible content. In an optional approach, a plurality of candidate promotional messages are available at the communication device. So configured, a particular candidate promotional messages can be selected to use in particular circumstances or settings to customize the user experience and/o to best leverage the promotional opportunity. The promotional message itself can comprise any of a wide variety of audible or other content, including but not limited to musical content, spoken content, sound-effects content, and so forth.

So configured, a user will receive a positive indication whenever a communication link being used by their communication device terminates. This, in turn, can be used to assure the user that the communication link is, in fact, initially operational at times when the user expects the communication link to be established. At the same time the user is apprised of promotional opportunities that can be particularly pertinent to their present location, circumstances, or the like.

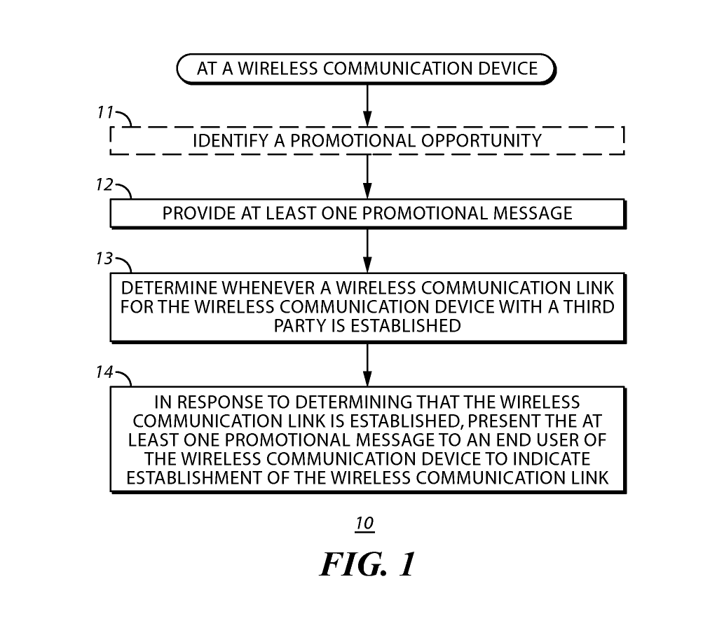

These and other benefits may become clearer upon making a thorough review and study of the following detailed description. Referring now to the drawings, and in particular to FIG. 1, a wireless communication device of choice (such as, but not limited to, cellular telephones and other two-way radios of various kinds and types, including platforms having voice and/or data modes of operation) can optionally identify 11 a promotional opportunity. This can be facilitated, for example, by having the wireless communication device actively or passively interact with a promotion server to learn of the promotional opportunity.

By one approach, for example, the wireless communication device may utilize a short-range two-way wireless communication methodology (such as, but not limited to, Bluetooth-compatible transmissions) to communicate with such a promotion server. The latter might simply transmit from time to time promotional information that may be of interest. In other cases the promotion server may provide specific promotional information in response to a specific query from the wireless communication device (as when the latter is configured, for example, to seek out sales and discounted offerings of fishing equipment, televisions, shoes, or the like).

This promotional information may be in the form of a promotional message that can be directly rendered for the end user of the wireless communication device or can comprise raw information that the wireless communication device edits to form a particular promotional message suitable for local rendering.

In any event, one way or the other, this process 10 provides 12 at least one promotional message at this wireless communication device. This promotional message can comprise, for example, audio-only content (such as, but not limited to, musical content (including promotional jingles, songs or song snippets, spoken content, and so forth), graphic-only content (including textual content, video content, still-image content, discount-coupon content, a scannable optical code (such as a one or two-dimensional bar code or the like), geographic information (such as a map or navigational prompts and instructions), promotional-code content (such as a unique code to be entered into a sweepstakes), a link to lead the device to a corresponding web page, and so forth) or a combination of audio and video content as desired.

This promotional message can be provided at essentially any time and can be refreshed and/or replaced as often as desired. Refreshing/replacement can be done transparently to the end user if desired.

This process 10 then provides for having the wireless communication device detect 13 when a wireless communication link with a third party is established (the expression “third party” of course refers to a calling or called party other than the network itself). This can comprise, for example, determining at the communication device itself that a wireless communication link has been established.

Various kinds of communication links are known in the art and consequently the details regarding detecting the establishment of any particular communication link will necessarily differ with variations in the enabling technology as will be well understood by those skilled in the art. In many cases the communication device will become aware of such establishment when an expected signal (such as a pilot signal, handshake signal, or other expected and recurrent signal) becomes present.

Upon detecting the establishment of such a wireless communication link, the communication device then presents 14 the aforementioned promotional message (for example, from amongst a plurality of candidate promotional messages). This can occur relatively quickly. For example, by one approach the rendering of the promotional message will begin within one second of detecting establishment of the link.

The promotional message can essentially have any desired duration. In many cases, it may be preferable to have a relatively short promotional message having a duration that does not exceed some predetermined maximum duration (such as, for example, three seconds, ten seconds, three minutes, and so forth).

When a plurality of such promotional messages are available to a given communication device, this step 14 will typically comprise selection of a particular promotional message from amongst the plurality of available messages. The selection criteria itself can vary with the needs and/or requirements of a given application and setting. To illustrate, one can select a particular promotional message from amongst a plurality of available promotional messages as a function, at least in part, of at least one of:

a specific other communication party (for example, a specific one of the available promotional messages can be used when signaling the termination of a communication link that had been used to facilitate a communication with a specific third party);

a time of day (for example, one promotional message might be used to indicate termination of communication links as may occur prior to noon and another, different promotional message might be used to indicate termination of communication links as may occur following noon);

a random selection amongst the available promotional messages;

the type of communication link that has been terminated (for example, one promotional message might be used to indicate termination of a cellular communication link and another, different promotional message might be used to indicate termination of a Bluetooth communication link);

a duration of the communication link prior to being terminated (for example, one promotional message might be used to indicate termination of a communication link that has been active for less than five minutes and another, different promotional message might be used to indicate termination of a communication link that has been active for more than five minutes); to name but a few.

As a more specific example, these teachings can be employed to facilitate providing a unique promotional message when a wireless communication link becomes established. More particularly, at least one audible and/or graphic signal can be provided at a two-way wireless communication device, which audible and/or graphic signal is uniquely used to identify establishment of the wireless communication link but which is not to be used to identify other events, conditions, and/or states at this communication device. Upon then detecting at the two-way wireless communication device that a given wireless communication link has been established, the audible and/or graphic signal can be rendered perceptible to the user of the device to thereby provide a unique signal to a user of the two-way wireless communication device that the given wireless communication link has been established while also conveying potentially relevant and useful promotional information.

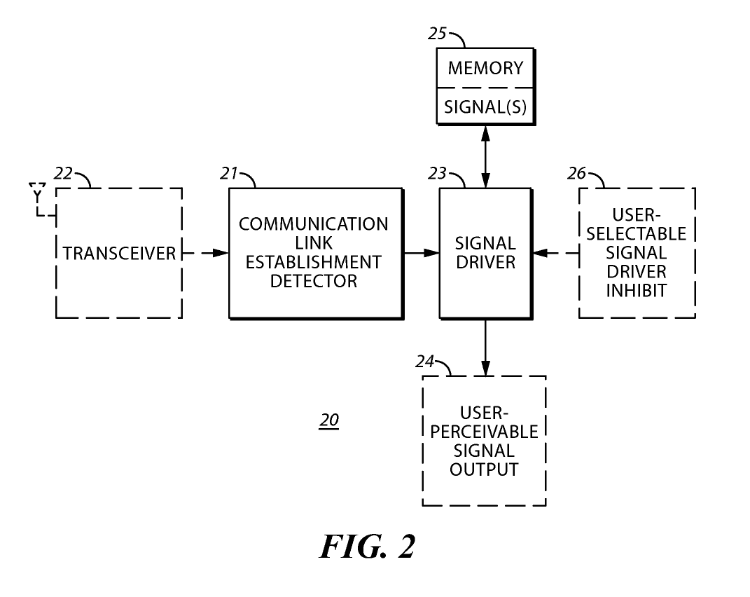

As noted above, these teachings can be usefully employed in conjunction with a wide variety of communications platforms. In many cases, as will be well understood by those skilled in the art, modern communication devices comprise partially or even wholly programmable platforms that can be readily configured to adopt and implement the described functionality. As a more specific illustrative example, and referring now to FIG. 2, a given communication device 20 can comprise, in relevant part, a communication link establishment detector 21 of choice that operably couples to, for example, a transceiver 22. So configured, the communication link establishment detector 21 serves, at least in part, to monitor the operation of the transceiver 22 and in particular to detect when a communication link (such as a wireless communication link) has been established with a third party platform.

The communication link establishment detector 21, in turn, operably couples to a signal driver 23 such as an audible and/or graphic signal driver. The latter serves to drive a user perceivable signal output 24 of choice and as may be appropriate to compatibly render the signal content of choice. In a preferred approach, the signal driver 23 operably couples to a memory 25 having one or more promotional messages stored therein. So configured, the signal driver 23 can select a particular one of a plurality of stored promotional messages when the memory 25 has a corresponding plurality of such messages stored therein.

So configured, those skilled in the art will understand and appreciate that such an apparatus will readily detect the establishment of a communication link and respond to such detection by providing a promotional message that uniquely identifies the communication link establishment event while also advising the end user of one or more promotional opportunities, instances, or the like. This, in turn, permits a user of the device to be well informed with respect to the presence of an extant communication link and to use and leverage that understanding with follow-on actions of choice to best accommodate a given condition.

There may be times, however, when a user may wish to temporarily defeat the above-described operability. For example, a given user may wish to disable this capability for some period of time while engaged in a particular activity or while visiting a particular venue. As another example, a given user may wish to effect an early conclusion of a provided signal during playback. To accommodate such a need, if desired, a user-selectable signal driver inhibit 26 can be operably coupled to the signal driver 23 to permit and facilitate such an action. Such a mechanism can assume any suitable form factor and human-machine interface of choice, including but not limited to push buttons, sliding switches, touch screen displays, a voice recognition interface, and so on.

It should now be evident and clear that these teachings permit a user to be apprised of when a communication link, such as a wireless communication link, has been established. Many users will appreciate that such information, important in and of itself, is also capable of being delivered in a personalized and highly customizable manner. Those skilled in the art will appreciate that these benefits are attainable with little fundamental change to many communication devices being necessary. In general, these teachings can be implemented in a highly cost effective manner.

At the same time, these teachings permit a given end user to be apprised of promotional offerings and opportunities that may well be of interest to them. When the wireless communication device has location capabilities, for example, that location information can be leveraged in conjunction with these teachings to provide promotional information to the end user regarding promotional opportunities in their immediate vicinity. As one simple example in these regards, this might comprise rendering an optical code on a display of the wireless communication device that will provide a discount on the purchase of a sandwich from a restaurant that is near to the end user's present location.

Such an approach can be used in connection with a promotions infrastructure and, for example, sources the aforementioned promotional information and/or promotional messages for use by the wireless communication device. Such infrastructure can further customize the user's experience by leveraging other information regarding that user and their preferences (by accessing, for example, a customer relationship management database, a loyalty program database, a specific profile maintained by the end user for this purpose, or the like). Such infrastructure can then interact with the wireless communication device using any of a variety of push and/or pull methodologies as are known in the art.

These teachings will also accommodate, if desired, providing the aforementioned promotional message to the wireless communication device at a time of need rather than prior to such a need. Such a communication might be sourced, for example, by a promotion server located at, or which comprises a part of, a point-of-sale platform that is also proximal to the wireless communication device at the time the connection becomes terminated.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example in these regards, once a given promotional message has been used to indicate the establishment of a call, the end user may be permitted to subsequently replay that promotional message, either indefinitely or for some period of time such as one day or the like. This, in turn, will permit the end user to avail themselves of information in the promotional message as needed.

I claim:

1. A method comprising:
at a wireless communication device:
providing at least one promotional message;
determining whenever a wireless communication link for the wireless communication device with a third party is established;
in response to determining that the wireless communication link is established, presenting the at least one promotional message to an end user of the wireless communication device to indicate establishment of the wireless communication link.

2. The method of claim 1 wherein the at least one promotional message comprises, at least in part, audio content.

3. The method of claim 2 wherein the audio content comprises, at least in part, at least one of:
musical content;
spoken content.

4. The method of claim 1 wherein the at least one promotional message comprises, at least in part, graphic content.

5. The method of claim 4 wherein the graphic content comprises, at least in part, at least one of:
textual content;
video content;
still-image content;
discount-coupon content;
a scannable optical code;
geographical information;
promotional-code content.

6. The method of claim 1 further comprising:
at the wireless communication device:
identifying a promotional opportunity;
obtaining promotional information pertaining to the promotional opportunity and using that promotional information as the at least one promotional message.

7. The method of claim 6 wherein identifying a promotional opportunity comprises learning of the promotional opportunity via interaction with a promotion server.

8. The method of claim 7 wherein the promotion server comprises, at least in part, a part of a point-of-sale component.

9. The method of claim 1 wherein providing at least one promotional message comprises modifying received promotional information as a function of information pertaining to an end user of the wireless communication device to thereby provide the at least one promotional message.
